(19) United States
(12) Patent Application Publication
(10) Pub. No.: US 2020/0221683 A1
(43) Pub. Date: Jul. 16, 2020

(54) Mite trap for the purpose of viewing and detecting mites

(71) Applicants: Jeffrey Lee Belak, Rensselaer, NY (US); Christopher Dwight Cunningham, Nassau, NY (US)

(72) Inventors: Jeffrey Lee Belak, Rensselaer, NY (US); Christopher Dwight Cunningham, Nassau, NY (US)

(21) Appl. No.: 16/246,784

(22) Filed: Jan. 14, 2019

(51) Int. Cl. A01M 23/00; A01M 23/08

(52) U.S. Cl. CPC A01M 23/005; A01M 23/08

(57) ABSTRACT

A mite trap for the purpose of early detection, viewing and assessment of mite infestation.

A mite trap that includes a mite attracting material.

A mite trap made of transparent plastic including a mite attractant.

Inside the trap is a compartment containing double sided tape or adhesive, hydrated super absorbent polymer, the pheromone neryl propionate, fish food flakes and fabric to absorb the attractants.

The absorbent material may be made of cotton, paper, wool, nylon or any other absorbent material.

The trap has an opening to allow mites to enter the trap and get stuck on double sided tape or adhesive in such a way that they can be easily viewed with the aid of a magnifying device.

The absorbent material that contains the mite attractant is positioned in the center of the trap with double sided tape or adhesive on each side of the mite attractant.

The attractant and double sided tape or adhesive are placed between transparent plastic slides and are visible through the trap.

### FIELD OF THE INVENTION

The present invention relates to a mite trapping device comprised of a mite attracting material encased in a transparent plastic case particularly to trap house inhibiting mites for early detection, viewing, assessments and monitoring the presence of mites.

### DESCRIPTION OF RELATED ART

Various known examples of mite trapping devices do not allow for easy viewing of the mites.

Conventional mite trapping devices that detect mites by the level of allergen do not detect the current presence of mites. The allergen created by mite feces can take years to accumulate before it is detectable.

The ability to easily view trapped mites allows an up to date assessment which is not possible using other known methods or devices.

Other mite trapping devices such as US PAT #2015/0033615 may detect a severe mite infestation after 90 days but has no guarantee of detection with or without the presence of mites inside the device.

### SUMMARY OF THE INVENTION

The mite trap creates an attractive environment for mites. Mites require a humidity level of at least 50% to survive. The mite trap includes hydrated super absorbent polymer that will slowly release moisture within the trap body creating a more humid environment than the area outside of the trap. If the mites avoid getting stuck to double sided tape or adhesive, they will remain in the trap due to the attractive environment

The idea is that the mites will get stuck on the double sided tape or adhesive in route to the mite attracting material allowing for easy viewing of the trapped mites.

Mites are attracted to fish food flakes and it is also a food source for mites encouraging mites to stay inside the trap.

Mites are known to be attracted to the pheromone (neryl propionate) up to a distance of 50 cm. Typical uses for the pheromone are for perfume scents and food flavoring. **(It is non toxic and FDA approved for use as a food product)**

90% of mites found in homes are found in mattresses and bedding. The trap can be placed in a pillow case or under bedding in a dark place without being easily noticed.

The objective is not to kill mites. Rather to identify the current presence of mites. Awareness of mites indicates that action should be taken. **(No mite trapping device available can effectively remove a mite infestation)**

The design of the trap is focused on easily viewing mites that have entered the trap which is the reason for using transparent materials.

The design of the trap maximizes the ability to view mites with the aid of a magnifying device. Mites are microscopic and cannot be viewed by the naked eye without the aid of a magnifying device with at least 10× magnification.

### BRIEF DESCRIPTION OF DRAWINGS

FIG. 1 is a 3D exploded view of the mite trap.

FIG. 2 is a cross sectional view of the mite trap.

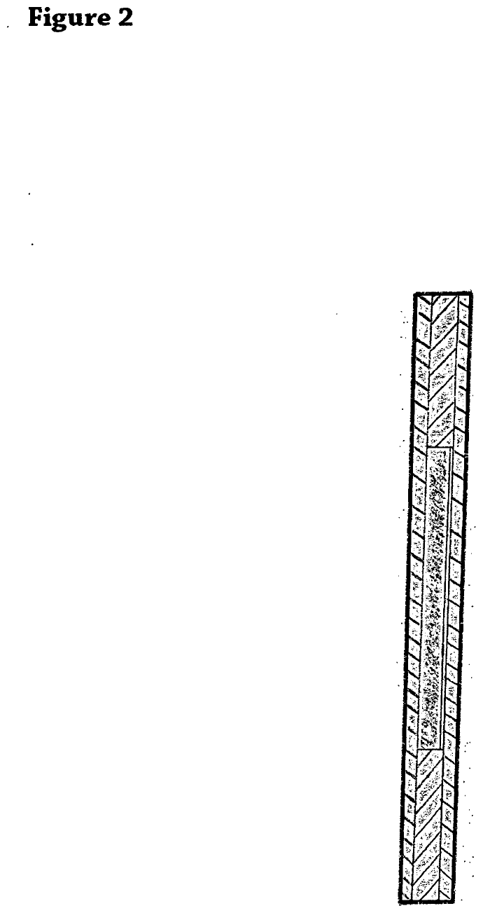

FIG. 3 is a top view looking through the transparent trap body.

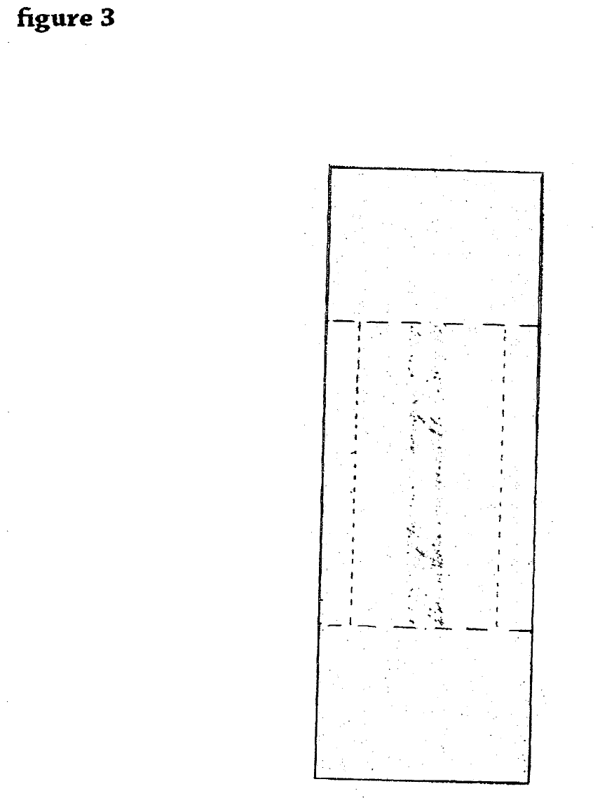

FIG. 4 is a partially cut away perspective view of the trap.

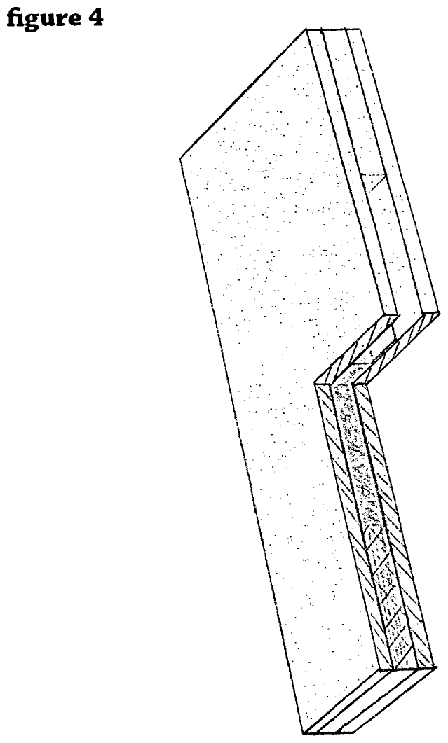

FIG. 5 is a second example of a cross sectional view.

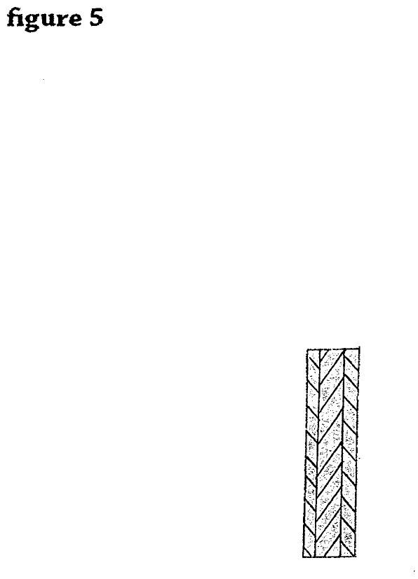

### DESCRIPTION OF EMBODIMENTS

Hereinafter are examples of the mite trap according to the present invention with reference to the attached drawings and the repetitive description is omitted.

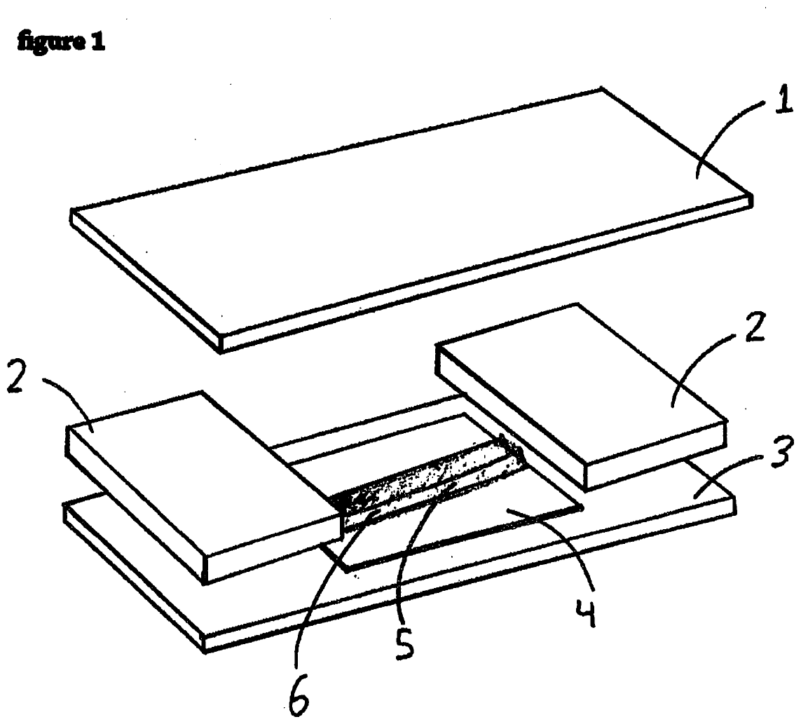

### First Example; See FIG. 1

The top slide 1 is attached to bottom slide 3 by using double sided sticky spacers 2. Mites range in width from 0.05 mm to 0.2 mm. The size of the gap is small enough to contain the attractant 6 and large enough for mites to enter while allowing the aroma of the attractant 6 to escape the trap.

The sticky spacers 2 in FIG. 1 have a thickness of at least 0.2 mm up to 1.5 mm

The double sided sticky tape or adhesive 4 in FIG. 1 is attached or applied to the bottom slide 3

The absorbent fabric 5 in FIG. 1 has the mite attractants 6 absorbed into it. The attractant 6 includes (BUT IS NOT LIMITED TO) a paste made of hydrated super absorbent polymer, fish food flakes and the pheromone neryl propionate.

The top slide 1 and bottom slide 3 are made of a see through transparent plastic to allow for easy viewing of mites with the aid of a magnifying device.

The double sided tape or adhesive 4 is transparent for easy viewing of mites with the aid of a magnifying device.

The mite attractant 6 contains hydrated super absorbent polymer which will slowly release moisture inside the trap creating an attractive environment for mites with a humidity level of over 50%.

Fish food flakes and neryl propionate are kneaded into hydrated super absorbent polymer. The combination of at least these ingredients are referred to as 6 in FIG. 1 and are applied to the fabric 5

The top slide 1 and bottom slide 3 in FIG. 1 are as thin as possible while maintaining some rigidity, approximately the thickness of commercially available plastic slides for a microscope. A certain rigidity is needed to prevent slide 1 from collapsing and sticking to double sided tape or adhesive 4 on bottom slide 3.

The environment inside the trap is such that it is ideal for attracting mites. Mites will seek a humid environment above 50% because they cannot survive humidity levels under 45%. The hydrated super absorbent polymer in the attractant 6 will slowly release moisture increasing the humidity level to over 50% inside the trap FIG. 1.

Fish food flakes are also known to attract mites and is included in the attractant 6.

The scent of the pheromone neryl propionate is known to attract mites up to a distance of 50 cm and is included in the mite attractant 6

The double sided tape or adhesive 4 is positioned so that mites will come in contact with it before reaching the attractant 6 creating an easy viewing area.

The combination of at least the elements in the attractant 6 will provide a more attractive environment inside of the trap than the area surrounding the trap.

The mite trap FIG. 1 is designed to have an overall size and shape that it is not easily noticed when placed in a pillow case or under a bed sheet.

The placement of mite trap FIG. 1 is such that it is in a dark environment such as in a pillow case or under a bed sheet. Mites prefer a dark space.

### Other Examples

A mite trap according to the present invention are not limited to the above described examples but can be variously modified within the scope of the spirit of the invention.

For example the trap can be any shape other than quadrangular shapes such as circular shapes, polygonal shapes, etc. The attracting material can be selected from various materials so long as it emits an attracting scent. The body of the trap is made of a see through transparent material for easy viewing with the aid of a magnifying device. The trap is designed for the purpose of viewing mites.

1. A mite trap for early detection, viewing and assessment purposes comprising of a transparent polymer body containing a mite attractant and double sided tape or adhesive to catch mites and allow for easy viewing with the aid of a magnifying device.

2. The mite trap of claim 1 wherein the interior surface has double sided tape or adhesive to trap mites before reaching the mite attractant.

3. The mite trap of claim 2 wherein there is attractant in the center of the adhesive.

4. The mite trap of claim 2 wherein the adhesive is in a defined area trapping mites before they reach the mite attractant.

5. The mite trap of claim 1 is comprised entirely of transparent material with the exceptions of the mite attractant and attractant absorbing material.

6. The mite trap of claim 2 contains either double sided tape or adhesive applied to at least one interior surface of the trap.

7. The mite trap of claim 6 wherein the purpose of the placement of the double sided tape or adhesive is to define the area where mites will be trapped to allow easy viewing with aid of a magnifying device.

8. The mite trap of claim 1 wherein the attractant contains hydrated super absorbent polymer, fish food flakes and the pheromone (neryl propionate)

9. The mite trap of claim 8 wherein the mite attracting materials are absorbed and contained within a fabric material.

10. The mite trap of claim 9 wherein the absorbent material is made of cotton, paper or any porous absorbent material.

11. The mite trap of claim 10 wherein the absorbent material is positioned in the center of the body in the interior of the trap.

12. The mite trap of claim 1 wherein the body of the trap is comprised of transparent polymer materials maintaining a gap allowing mites to easily enter the trap.

13. The mite trap of claim 12 wherein the gap is sized to contain the mite attracting material while also allowing mites to easily enter the trap.

14. The mite trap of claim 12 wherein the gap is at least 0.2 mm

15. The mite trap of claim 1 wherein the overall size and shape of the trap is such that it can be placed in a pillow case or under a bed sheet and remain unnoticed.
